(19) United States
(12) Patent Application Publication
(10) Pub. No.: US 2004/0001045 A1
(43) Pub. Date: Jan. 1, 2004

(54) Rotary-type encoder structure

(76) Inventor: Ken-Pei Hu, Taipei Hsien (TW)

Correspondence Address: BACON & THOMAS, PLLC, 625 SLATERS LANE, FOURTH FLOOR, ALEXANDRIA, VA, 22314

(21) Appl. No.: 10/179,255

(22) Filed: Jun. 26, 2002

(51) Int. Cl. G09G 5/08

(52) U.S. Cl. 345/163

(57) ABSTRACT

The invention is to provide a rotary-type encoder structure utilized by a device to control movement and scrolling on the screen of a display, which has a resilient projecting member unitarily formed on a footing such that the resilient projecting member is postured against and between arcuate sections contiguously disposed along the inner wall of a recess in one side of a roller wheel; such that, when the user rotates the roller wheel, the coordinative relationship between the said arcuate sections and the said projecting member enables all intervals of engagement are identical during each revolution of the roller wheel to achieve the objective of page turning or movement on the screen.

### BACKGROUND OF THE INVENTION

1) Field of the Invention

The invention herein relates to a rotary-type encoder structure.

2) Description of the Prior Art

In addition to keyboards, the mouse and the trackball are commonly observed conventional computer peripherals utilized to achieve movement on the screen of a display, with the mouse and the trackball moving a cursor by means of a spherical body that is gyrated. However, due to differences in the application of force, the distance traveled by the gyrated spherical body varies and maneuvering about the said screen does not conform to the position actually required such that when a user moves page frames for viewing on the display (referring to browsing websites on the Internet), the mouse must be slowly shifted upward or downward a certain distance, or the trackball continuously rolled to adjust the required position on said page frames. As such, much time is consumed and, furthermore, the inability of accurate movement to a specific position is far from ideal in terms of utilization.

To address the preceding situation, the applicant of the invention herein invented a “Encoder Wheel Arrangement” that was granted a U.S. Pat. No. 5,952,997; referring to FIG. 4 and FIG. 5, the said structure has a roller wheel 5, a recess is hollowed out in one side of the said roller wheel 5 and a plurality of arcuate sections 51 are contiguously disposed along the inner wall of the said recess, with the said arcuate sections 51 situated at equidistant intervals apart; a journal 53 extends outward from another fixed position on the said roller wheel 5; internal splines 54 are formed at the extremity of the journal 53 facing the said recess; and a ring 55 constructed of a rubber material is slipped onto the surface of the said roller wheel 5.

Referring again to FIG. 4 and FIG. 5, the said structure has a footing 6 that accommodates the said roller wheel 5; a bore 61 is formed at a fixed position in the footing 6 and a minimum of one mounting pin 63 extends downward from the said footing 6, with an inset hook 65 articulated near the lower tip of each said mounting pin 63; the said inset hook 65 is inserted into the through-hole 71 of a circuit board 7 to anchor the said footing 6 onto the said circuit board 7. A channel 66 is disposed in one lateral surface of the said footing 6 and a projecting member 67 in a coordinative relationship with the arcuate sections 51 on the roller wheel 5 is situated within the said channel 66 and a plurality of elastic components 671 are positioned between the said projecting member 67 and the channel 66 of the said footing 6 such that the said projecting member 67 thereby slides into and against the arcuate sections 51 on the roller wheel 5; and protrusions 673 situated between the projecting member 67 and the elastic components 671 enable the sleeving of the said elastic components 671 onto the said protrusions 673.

A shaft 8 is inserted into the said footing 6; external splines 81 that fit into the internal splines 54 of the roller wheel 5 are disposed on the extremity of the said shaft 8 facing the said roller wheel 5; the said shaft 8 is inserted through the bore 61 of the footing 6 and, furthermore, the external splines 81 are secured to the internal splines 54 of the said roller wheel 5 such that the roller wheel 5 is rotatably conjoined onto the said footing 6; a turn disc 83 is situated on the opposite extremity of the said shaft 8 away from the roller wheel 5 and a plurality of spaces 831 are formed at equal intervals apart along the circumference of the said turn disc 83.

Referring to FIG. 4 and FIG. 5, a transmitting component 73 and a receiving component 75 are positioned on the said circuit board 7 at the two sides of the turn disc 83; a first support 77 and a second support 78 are respectively affixed onto the said circuit board 7, wherein the said first support 77 has a pivot hole 771 for the journal 53 of the roller wheel 5 to enable the rotational coupling of the roller wheel 5 onto the first support 77 and the said second support 78 has a pivot hole 781 for the extremity of the shaft 8 opposite from the external splines 81 to enable the rotational coupling of the shaft 8 onto the second support 78.

When the user rotates the roller wheel 5 and the projecting member 67 resting against the said arcuate sections 51 slides into each arcuate section 51 during the course of rotation, the said projecting member 67 engages an arcuate section 51 and is rotated to engage the next arcuate section 51 such that all intervals of engagement are identical during each revolution of the roller wheel 5 to achieve the objective of page turning or movement, and as the turn disc 83 synchronously rotates along with the roller wheel 5, the spaces 831 on the turn disc 83 trigger the transmission of corresponding intermittent signals by the transmitting component 73, wherein the differing continuous signals issued by the transmitting component 73 and the disruption thereof by the spaces 831 are sent to the receiving component 75, and after encoding is executed by the receiving component 75, the data obtained is transferred to a controller component that executes operating tasks to accomplish an instance of page or line movement.

However, in the said “Encoder Wheel Arrangement” of U.S. Pat. No. 5,952,997, the elastic components 671 must be positioned between the said projecting member 67 and the channel 66 of the said footing 6 to enable the elasticity of the elastic components 671 to posture the said projecting member 67 against the arcuate sections 51 on the roller wheel 5; as such, when the said encoder wheel is assembled, it is necessary to additionally install the elastic components 671 and the projecting member 67 by hand which results in the shortcomings of time consumption and higher production costs and, furthermore, if the said elastic components 671 are improperly installed or resilience fatigue occurs in the said elastic components 671 due to prolonged utilization, the said projecting member 67 can no longer be precisely positioned between the arcuate sections 51 of the roller wheel 5, resulting in an incapability to perform accurate movement to a specific position on a display screen.

### SUMMARY OF THE INVENTION

In view of the shortcomings of the said conventional rotary-type encoder structure, the invention herein provides a rotary-type encoder structure, the innovative features of which includes the fabrication of the said projecting member and the footing as a one-piece, unitarily integrated structure, thereby eliminating the manual installation of the elastic components and the projecting member, thereby saving assembly time to achieve the objective of lowering production costs.

Based on the said objective, the invention herein has a roller wheel, a recess is hollowed out in one side of the said roller wheel, a plurality of arcuate sections are contiguously disposed along the inner wall of the said recess, and the recess is rotatably sleeved onto a footing; a resilient projecting member is unitarily formed on the said footing such that the said resilient projecting member is postured against and between the said arcuate sections, thereby locating the said roller wheel at relative positions; the said encoder has a shaft and after one extremity of the said shaft is inserted into the said footing, it is secured to the center position of the said roller wheel and a turn disc is situated on the opposite extremity of the said shaft such that the said turn disc rotates synchronously along with the said roller wheel; as such, when the user rotates the roller wheel, the coordinative relationship between the said arcuate sections and the said projecting member is such that all intervals of engagement are identical during each revolution of the roller wheel to achieve the objective of page turning or movement and, as the turn disc synchronously rotates along with the roller wheel, the data is transferred.

Another objective of the invention herein consists of positioning a transmitting component and a receiving component on a circuit board at the two sides of the said turn disc such that when the turn disc rotates along with the roller wheel, the spaces on the turn disc trigger the transmission of corresponding intermittent signals by the transmitting component, wherein the differing continuous signals issued by the transmitting component and the disruption thereof by the spaces are sent to the receiving component and, after encoding is executed by the receiving component, the data obtained is transferred to a controller component that executes operating tasks to accomplish an instance of page or line movement.

### BRIEF DESCRIPTION OF THE DRAWINGS

FIG. 1 is an exploded drawing of the invention herein (1).

FIG. 2 is an exploded drawing of the invention herein (2).

FIG. 3 is an isometric drawing of the invention herein with its circuit board.

FIG. 4 is an isometric drawing of the conventional structure.

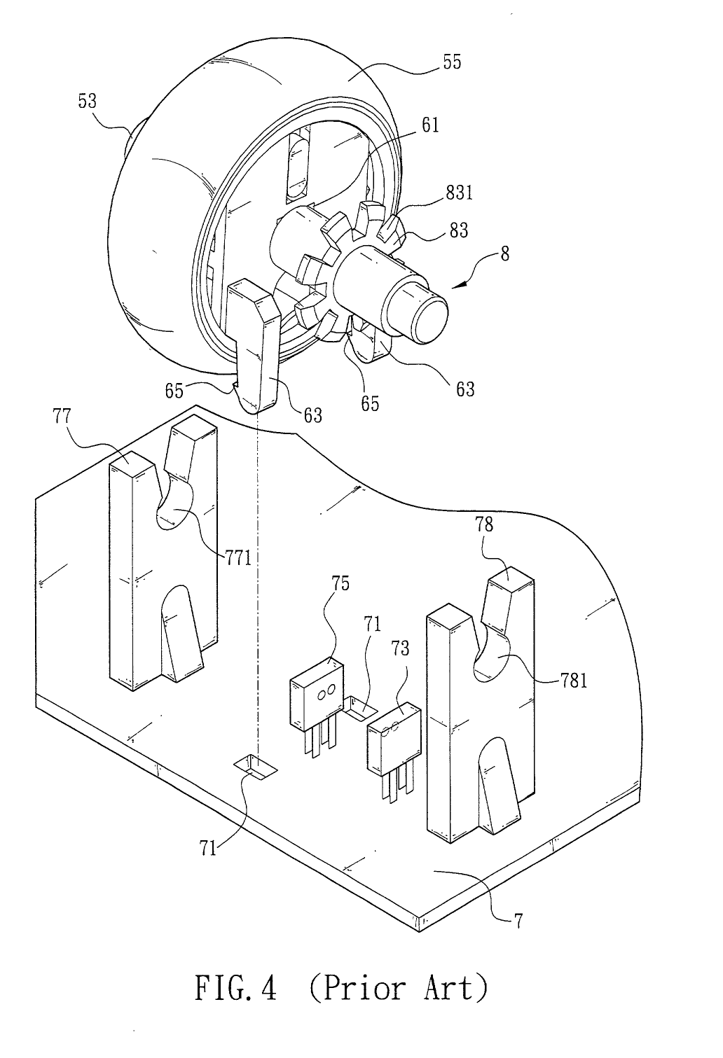

FIG. 5 is an exploded drawing of the conventional structure.

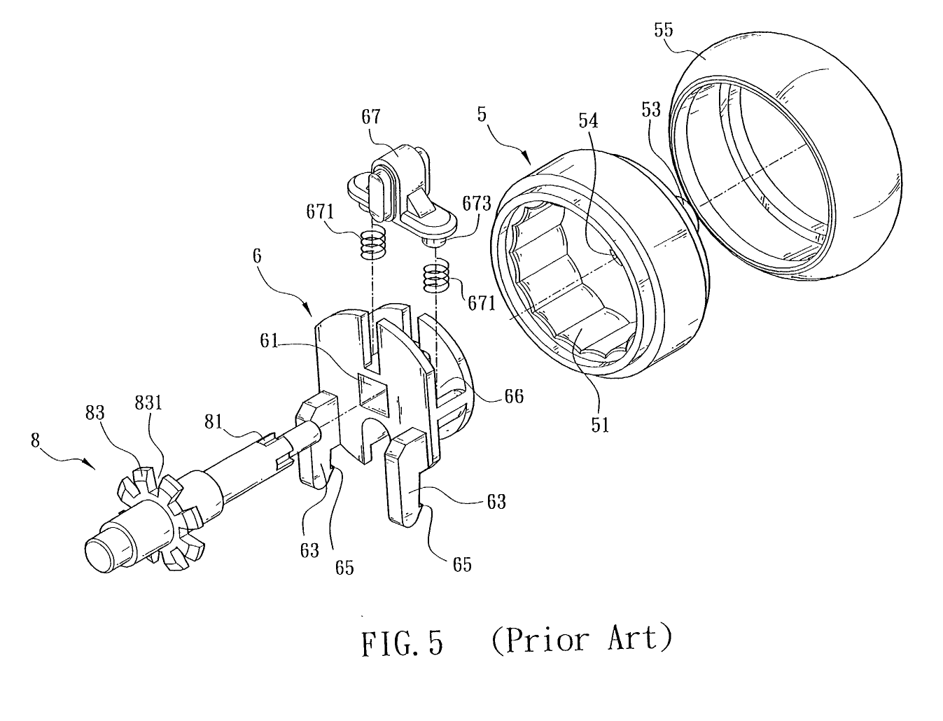

### DETAILED DESCRIPTION OF THE INVENTION

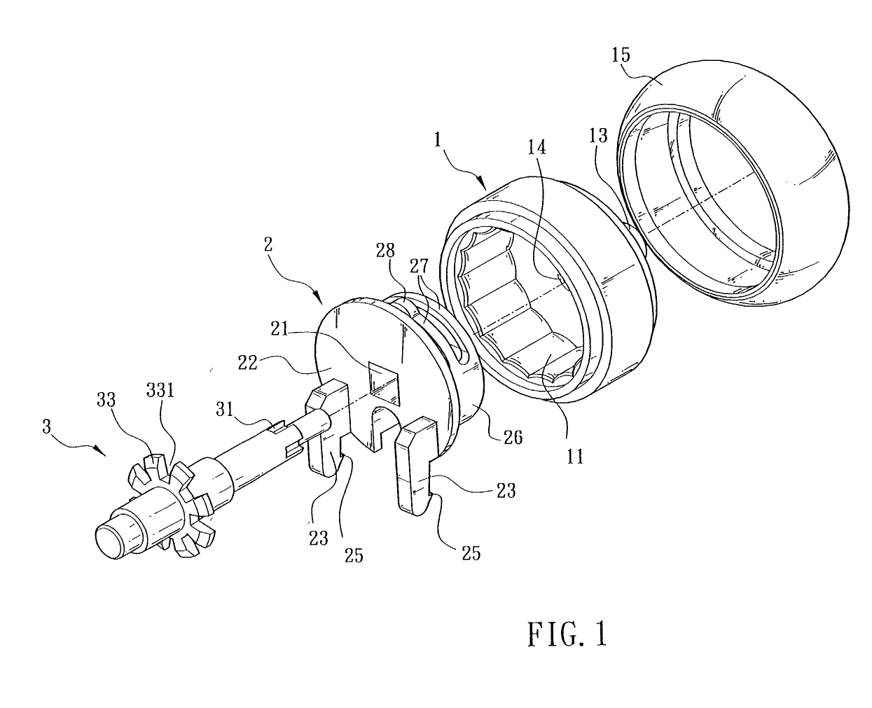

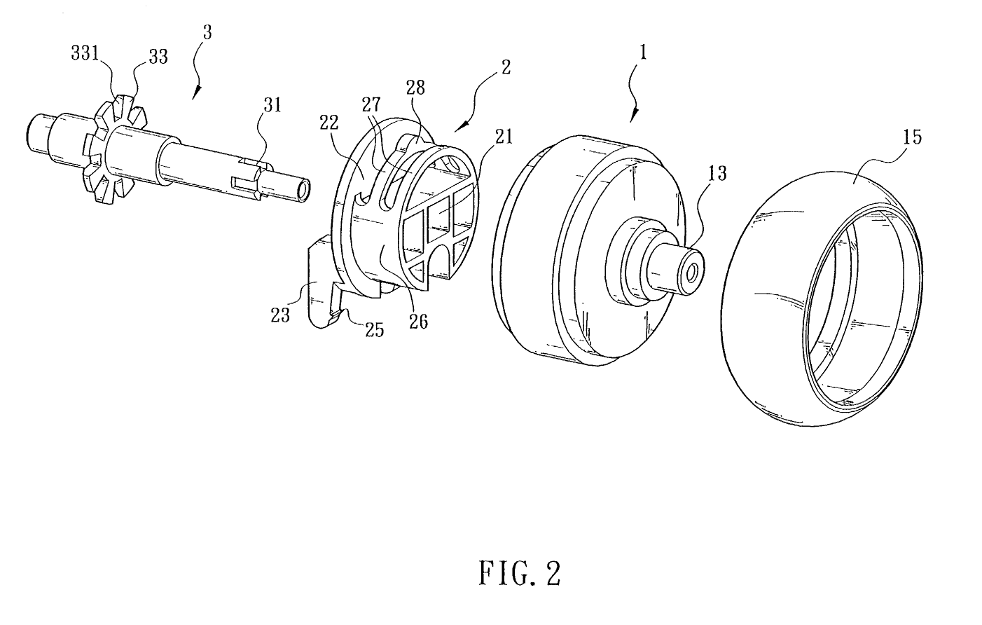

The invention here is a rotary-type encoder structure, referring to FIG. 1 and FIG. 2, consisting of a device utilized to control movement and scrolling on the screen of a display, the said device is installable on a remote control, a mouse, a keyboard, or other electronic product, but is utilized on a mouse in the embodiment herein; the said device has a roller wheel 1, a recess is hollowed out in one side of the said roller wheel 1 and a plurality of arcuate sections 11 are contiguously disposed along the inner wall of the said recess, with the said arcuate sections 11 situated at equidistant intervals apart; a journal 13 extends outward from the near center at the other side of the said roller wheel 1; internal splines 14 are formed at the extremity of the journal 13 facing the said roller wheel 1 arcuate sections 11; and a ring 15 constructed of a rubber material is slipped onto the surface of the said roller wheel 1.

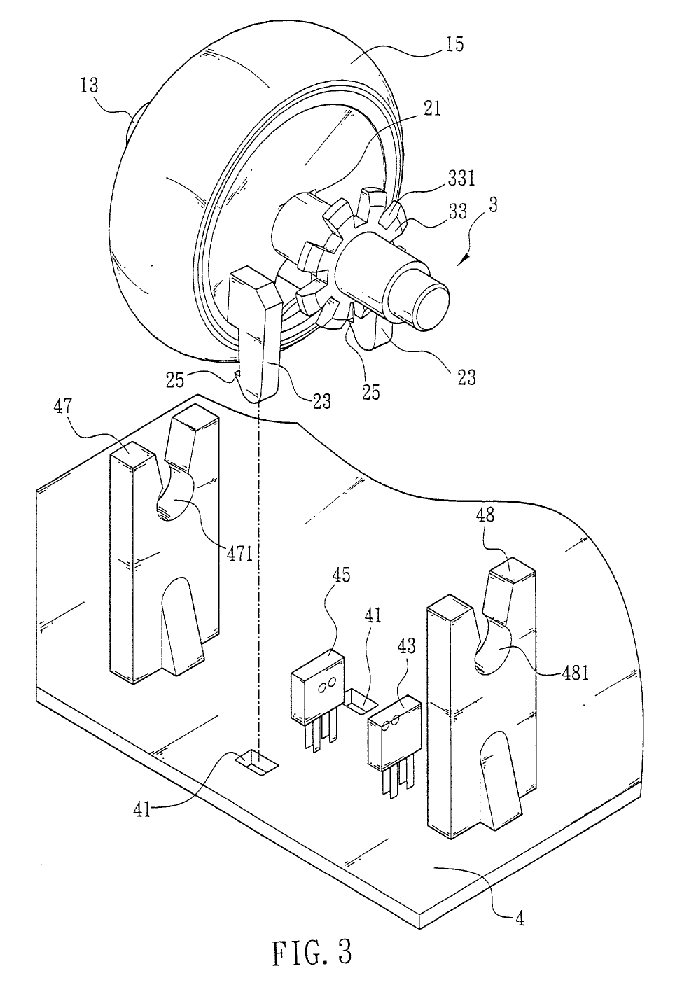

Referring again to FIG. 1, FIG. 2 and FIG. 3, the said device has a footing 2 for the said roller wheel 1 and the recess of the said roller wheel 1 is rotatably sleeved onto the said footing 2; a bore 21 is formed in the footing 2 towards the internal splines 14 position of the roller wheel 1 and a wall surface 22 is formed on the other side of the said footing 2 opposite from the roller wheel 1 recess; the said wall surface 22 is dimensioned such that it covers the opening of said recess; a minimum of one mounting pin 23 extends downward from the said wall surface 22, with an inset hook 25 articulated near the lower tip of each said mounting pin 23; the said inset hook 25 is inserted into the through-hole 41 of a circuit board 4 to anchor the footing 2 onto the circuit board 4 (as shown in FIG. 3); a cylindrical body 26 of a diameter slightly smaller than that of the said recess is situated on the side of the said footing 2 facing the roller wheel 1 recess and the said cylindrical body 26 is installed into the said recess such that the roller wheel 1 is capable of rotating on the said footing 2; a resilient projecting member emerges from the said cylindrical body 26; the said resilient projecting member is unitarily formed on the said footing 1, with a flexile arm 27 symmetrically jutting from the said resilient projecting member; the said flexile arm 27 and the cylindrical body 26 are of a spatially reticulated arrangement such that the said flexile arm 27 has elasticity, wherein a nib 28 at the top extremity of the flexile arm 27 is aligned and, furthermore, in a coordinative relationship with the arcuate sections 11 on the said roller wheel 1 such that the said nib 28 is postured against the arcuate sections 11 of the roller wheel 1 by the elasticity of the flexile arm 27, thereby locating the said roller wheel 1 at relative positions.

A shaft 3 is inserted into the said footing 2; external splines 31 that fit into the internal splines 14 of the roller wheel 1 are disposed on the extremity of the said shaft 3 facing the roller wheel 1; after the said shaft 3 is inserted through the bore 21 of the footing 2, the external splines 31 are secured to the internal splines 14 of the roller wheel 1 such that the roller wheel 1 is rotatably conjoined onto the said footing 2; a turn disc 33 is situated on the opposite extremity of the said shaft 3 away from the roller wheel 1 and a plurality of spaces 331 are formed at equal intervals apart along the circumference of the said turn disc 33.

Referring to FIG. 1, FIG. 2 and FIG. 3, a transmitting component 43 and a receiving component 45 are positioned on the said circuit board 4 at the two sides of the turn disc 33; a first support 47 and a second support 48 are respectively affixed onto the said circuit board 4, wherein the said first support 47 has a pivot hole 471 for the roller wheel 1 journal 13 to enable the rotational coupling of the roller wheel 1 onto the first support 47 and the said second support 48 has a pivot hole 481 for the extremity of the shaft 3 opposite from the external splines 31 to enable the rotational coupling of the shaft 3 onto the second support 48.

Given the said structural assembly, when the user rotates the roller wheel 1 and the nib 28 resting against the said arcuate sections 11 slides into each arcuate section 11 during the course of rotation, the said nib 28 engages an arcuate section 11 and is rotated to engage the next arcuate section 11 such that all intervals of engagement are identical during each revolution of the roller wheel 1 to achieve the objective of page turning or movement and, as the turn disc 33 synchronously rotates along with the roller wheel 1, the spaces 331 on the turn disc 33 trigger the transmission of corresponding intermittent signals by the transmitting component 43, wherein the differing continuous signals issued by the transmitting component 43 and the disruption thereof by the spaces 331 are sent to the receiving component 45 and, after encoding is executed by the receiving component 45, the data obtained is transferred to a controller component that executes operating tasks to accomplish an instance of page or line movement.

As such, since the invention herein utilizes plastic injection technology and a one-piece fabrication method to fabricate the said resilient projecting member and the footing 2 as a one-piece, unitarily integrated structure that dispenses with the conventional encoder wheel and the need to additionally install the elastic component and projecting member by hand during assembly, the present invention significantly reduces production procedures as well as lessens production errors, thereby lowering production costs.

What is claimed is

1. A rotary-type encoder structure comprised of:
at least a roller wheel, a recess is hollowed out in one side of the said roller wheel and a plurality of arcuate sections are contiguously disposed along the inner wall of the said recess;
a footing, the said footing enabling the said recess to be rotatably sleeved onto it and, furthermore, having a resilient projecting member emerging from it; the said resilient projecting member is unitarily formed on the said footing such that it is postured against the said arcuate sections, thereby locating the said roller wheel at relative positions;
a shaft; after one extremity of the said shaft is inserted through the said footing, it is secured to the center position of the said roller wheel; and a turn disc is situated on the opposite extremity of the said shaft such that the said turn disc rotates synchronously along with the said roller wheel;
as such, when the said roller wheel is rotated, the said projecting member is in a coordinative relationship with the said arcuate sections such that all intervals of engagement are identical during each revolution of the said roller wheel.

2. A rotary-type encoder structure as claimed in claim 1 in which the said roller wheel has a journal extending outward from the near center of the other side of the said roller wheel and internal splines are formed at the extremity of the said journal facing the said arcuate sections such that one extremity of the said shaft can be inserted into the said internal splines.

3. A rotary-type encoder structure as claimed in claim 2 in which the said footing has a bore formed towards the said internal splines position of the said roller wheel; a minimum of one mounting pin extends downward from the said footing; a cylindrical body of a diameter slightly smaller than that of the said recess is situated on the other side of the said footing and the said cylindrical body is installed into the said roller wheel recess such that the said roller wheel is capable of rotating on the said footing; the said cylindrical body has a flexile arm symmetrically jutting from its upper extremity; the said flexile arm and the said cylindrical body are of a spatially reticulated arrangement such that the said flexile arm has elasticity, wherein a nib at the top extremity of the said flexile arm is in a coordinative relationship with the said arcuate sections on the said roller wheel such that the said nib is postured against the said roller wheel arcuate sections by the elasticity of the said flexile arm, thereby locating the said roller wheel at relative positions.

4. A rotary-type encoder structure as claimed in claim 3 in which the said shaft is inserted through the said bore of the said footing and one extremity is secured to the said internal splines of the said roller wheel such that the said roller wheel is rotatably conjoined onto the said footing; a turn disc is situated on the opposite extremity of the said shaft away from the said roller wheel and a plurality of spaces are formed at equal intervals apart along the circumference of the said turn disc.

5. A rotary-type encoder structure as claimed in claim 4 in which the said encoder is also comprised of a circuit board; the said circuit board has respectively affixed onto it a first support and a second support, wherein the said first support has a pivot hole for the said roller wheel journal to enable the rotational coupling of the said roller wheel onto the said first support and the said second support has a pivot hole for the extremity of the said shaft opposite from the said external splines to enable the rotational coupling of the said shaft onto the said second support; the said circuit board also has a transmitting component and a receiving component positioned at the two sides of the said turn disc; and through-holes are formed in the said circuit board for the said footing, the through-holes enabling the anchoring of the said footing onto the said circuit board.

6. A rotary-type encoder structure as claimed in claim 5 in which the said roller wheel has a ring constructed of a rubber material fitted onto its surface.

7. A rotary-type encoder structure as claimed in claim 6 in which the said footing has a wall surface between its said mounting pin and said cylindrical body, with the said wall surface dimensioned such that it covers the opening of the said recess.

8. A rotary-type encoder structure as claimed in claim 7 in which the said mounting pin has an inset hook articulated near its lower tip and the said inset hook is inserted into the said through-hole of the said circuit board to anchor the said footing onto the said circuit board.

9. A rotary-type encoder structure as claimed in claim 8 in which the extremity of the said shaft opposite from the said roller wheel has the said external splines that fit into the said internal splines of the said roller wheel; the said shaft is inserted through the said bore of the said footing and, furthermore, its said external splines are secured into the said internal splines of the said roller wheel.
